(19) United States
(12) Patent Application Publication
(10) Pub. No.: US 2025/0263258 A1
(43) Pub. Date: Aug. 21, 2025

(54) MEDIUM CONVEYING DEVICE AND IMAGE FORMING APPARATUS

(71) Applicant: FUJIFILM Business Innovation Corp., Tokyo (JP)

(72) Inventors: Hiroyuki TAMAI, Kanagawa (JP); Ryuga OISHI, Kanagawa (JP); Ryosuke YAMAJI, Kanagawa (JP)

(73) Assignee: FUJIFILM Business Innovation Corp., Tokyo (JP)

(21) Appl. No.: 18/786,058

(22) Filed: Jul. 26, 2024

(30) Foreign Application Priority Data
Feb. 19, 2024 (JP) 2024-023067

(51) Int. Cl. B65H 5/06; G03G 15/00

(52) U.S. Cl. CPC B65H 5/062; G03G 15/6529; B65H 2402/54; B65H 2404/1441

(57) ABSTRACT

A medium conveying device includes: a first roller that is rotatably supported; a second roller that conveys a recording medium while nipping the recording medium between the first roller and the second roller; a biasing member that is disposed on a side opposite to the second roller with the first roller interposed between the second roller and the biasing member and biases the first roller toward the second roller; a transmission member that is disposed between the biasing member and the first roller, is restricted by the first roller from moving relative to the first roller in an intersecting direction intersecting a biasing direction of the biasing member and an axial direction of the first roller, and transmits a biasing force of the biasing member to the first roller; and an adjustment member that adjusts the biasing force applied by the biasing member to the first roller by causing the transmission member to approach or be separated from the first roller in the biasing direction.

### CROSS-REFERENCE TO RELATED APPLICATIONS

This application is based on and claims priority under 35 USC 119 from Japanese Patent Application No. 2024-023067 filed Feb. 19, 2024.

### BACKGROUND

### (i) Technical Field

The present disclosure relates to a medium conveying device and an image forming apparatus.

### (ii) Related Art

Japanese Unexamined Patent Application Publication No. 2014-148379 discloses a recording medium supply device in which a pressing member, disposed at one end portion of a first rotary arm, is configured to press against an uppermost surface of sheet-like recording media placed in a stacked state on a recording medium mounting portion. The recording medium supply device includes a first biasing unit that is movably disposed along a longitudinal direction of the first rotary arm. The first biasing unit applies a pressing force to the pressing member by biasing the first rotary arm in a rotating direction. By moving the first biasing unit, the pressing force applied to the pressing member can be changed.

### SUMMARY

In the related art, in order to adjust the force with which a recording medium is nipped, a biasing member, a transmission member, and an adjustment member are provided. The biasing member biases a first roller toward a second roller. The transmission member is disposed between the biasing member and the first roller and transmits the biasing force of the biasing member to the first roller. The adjustment member adjusts the degree of the biasing force transmitted by the transmission member.

Specifically, the transmission member is disposed so as to come into contact with the first roller only from a biasing direction of the biasing member. In such a configuration, there are some cases where the transmission member may move relative to the first roller in an intersecting direction intersecting the biasing direction and an axial direction of the first roller.

Aspects of non-limiting embodiments of the present disclosure relate to suppressing a transmission member from moving relative to a first roller in an intersecting direction intersecting a biasing direction of a biasing member and an axial direction of the first roller, compared to a case where the transmission member is in contact with the first roller only from the biasing direction.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a medium conveying device including: a first roller that is rotatably supported; a second roller that conveys a recording medium while nipping the recording medium between the first roller and the second roller; a biasing member that is disposed on a side opposite to the second roller with the first roller interposed between the second roller and the biasing member and biases the first roller toward the second roller; a transmission member that is disposed between the biasing member and the first roller, is restricted by the first roller from moving relative to the first roller in an intersecting direction intersecting a biasing direction of the biasing member and an axial direction of the first roller, and transmits a biasing force of the biasing member to the first roller; and an adjustment member that adjusts the biasing force applied by the biasing member to the first roller by causing the transmission member to approach or be separated from the first roller in the biasing direction.

### BRIEF DESCRIPTION OF THE DRAWINGS

Exemplary embodiments of the present disclosure will be described in detail based on the following figures, wherein:

FIG. 1 is a configuration diagram schematically illustrating an image forming apparatus according to a first exemplary embodiment of the present disclosure;

FIG. 2 is a configuration diagram schematically illustrating an image forming unit included in the image forming apparatus according to the first exemplary embodiment of the present disclosure;

FIG. 3 is a perspective view illustrating a medium conveying device according to the first exemplary embodiment of the present disclosure;

FIG. 4 is an enlarged perspective view illustrating the medium conveying device according to the first exemplary embodiment of the present disclosure;

FIG. 5 is an enlarged front view illustrating the medium conveying device according to the first exemplary embodiment of the present disclosure;

FIG. 6 is an operation diagram used for describing an operation of the medium conveying device according to the first exemplary embodiment of the present disclosure;

FIG. 7 is an operation diagram used for describing an operation of the medium conveying device according to the first exemplary embodiment of the present disclosure;

FIG. 8 is an enlarged front view illustrating a medium conveying device according to a second exemplary embodiment of the present disclosure;

FIG. 9 is an operation diagram used for describing an operation of the medium conveying device according to the second exemplary embodiment of the present disclosure; and

FIG. 10 is an operation diagram used for describing an operation of the medium conveying device according to the second exemplary embodiment of the present disclosure.

### DETAILED DESCRIPTION

### First Exemplary Embodiment

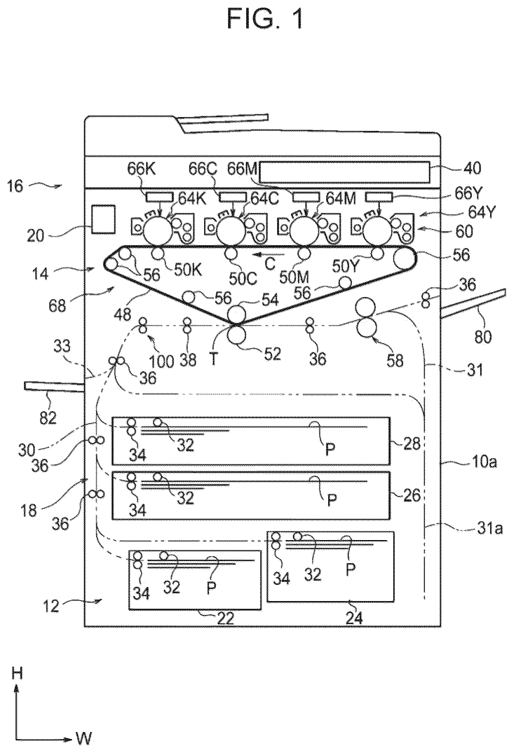

Examples of a medium conveying device and an image forming apparatus according to a first exemplary embodiment of the present disclosure will be described with reference to FIG. 1 to FIG. 7. In each of the drawings, an arrow H indicates a vertical direction, that is, an up-down direction, an arrow W is orthogonal to the arrow H and indicates a horizontal direction, that is, a width direction, and an arrow D is orthogonal to the arrow H and the arrow W and indicates a horizontal direction, that is, a depth direction.

### (Overall Configuration of Image Forming Apparatus 10)

As illustrated in FIG. 1, an image forming apparatus 10 includes a sheet accommodation section 12, a main operation section 14, a document reading section 16, and a display section 40 that are arranged in this order from the lower side to the upper side in the up-down direction. The image forming apparatus 10 further includes a conveying section 18 and a manager 20. The conveying section 18 conveys sheet members P as recording media. The manager 20 manages the operation of each section.

The sheet accommodation section 12 accommodates the sheet members P. The main operation section 14 forms an image on each sheet member P conveyed from the sheet accommodation section 12. The document reading section 16 reads an image on a document. The display section 40 shows a screen where a user interacts with the image forming apparatus 10 to exchange information.

### [Sheet Accommodation Section 12]

As illustrated in FIG. 1, the sheet accommodation section 12 includes a first accommodation section 22, a second accommodation section 24, a third accommodation section 26, and a fourth accommodation section 28 that are capable of accommodating sheet members P of different sizes. The first accommodation section 22, the second accommodation section 24, the third accommodation section 26, and the fourth accommodation section 28 each include a feed roller 32 and a multi feeding prevention roller 34. The feed roller 32 feeds the accommodated sheet members P one by one. The multi feeding prevention roller 34 conveys the fed sheet members P one by one to a conveying path 30 in the image forming apparatus 10.

### [Conveying Section 18]

As illustrated in FIG. 1, the conveying section 18 includes a plurality of conveying rollers 36 that receive sheet members P from the multi feeding prevention roller 34 and convey the sheet members P one by one along the conveying path 30. The conveying section 18 further includes an alignment roller 38 disposed upstream of a transfer position T, which will be described later, in a conveying direction of the sheet members P (hereinafter, simply referred to as a “sheet conveying direction”). The alignment roller 38 temporarily stops each sheet member P, and feeds the sheet member P to a second transfer position at a predetermined timing. The conveying section 18 further includes a medium conveying device 100 that receives each sheet member P from the conveying rollers 36 and delivers the sheet member P to the alignment roller 38.

An upstream portion of the conveying path 30 in the sheet conveying direction extends upward from below on one side in the width direction. A downstream portion of the conveying path 30 in the sheet conveying direction extends from one side to the other side in the width direction, and reaches a discharge section 80 through which the sheet members P are discharged to the outside of an apparatus main body 10a. The medium conveying device 100, described above, is disposed at an end portion of a transition portion of the conveying path 30 where the conveying direction of the sheet members P changes. The medium conveying device 100 will be described in detail later.

A duplex conveying path 31 is connected to a downstream end portion of the conveying path 30 in the sheet conveying direction. Each sheet member P is conveyed and reversed along the duplex conveying path 31 so that an image is formed on the reverse side of the sheet member P.

The duplex conveying path 31 includes a switchback path 31a. Each sheet member P fed from the switchback path 31a is reversed upside down and is fed to an upper end portion of the upstream portion of the conveying path 30 in the sheet conveying direction.

A manual feed path 33 is connected to the upper end portion of the upstream portion of the conveying path 30 in the sheet conveying direction. A sheet member P supplied from a manual feed section 82 disposed outside the apparatus main body 10a is conveyed along the manual feed path 33.

### [Main Operation Section 14]

As illustrated in FIG. 1, the main operation section 14 includes an image forming section 60, a transfer unit 68, and a fixing device 58. The image forming section 60 forms a toner image. The transfer unit 68 transfers the toner image onto each sheet member P. The fixing device 58 fixes the toner image formed on the sheet member P to the sheet member P.

### —Image Forming Section 60—

The image forming section 60 includes image forming units 64K, 64C, 64M, and 64Y that form toner images of black (K), cyan (C), magenta (M), and yellow (Y), respectively. In the following description, in a case where the image forming units 64K, 64C, 64M, and 64Y are not particularly distinguished from one another, K, C, M, and Y, each of which is added at the end of the reference numeral, may be omitted in some cases.

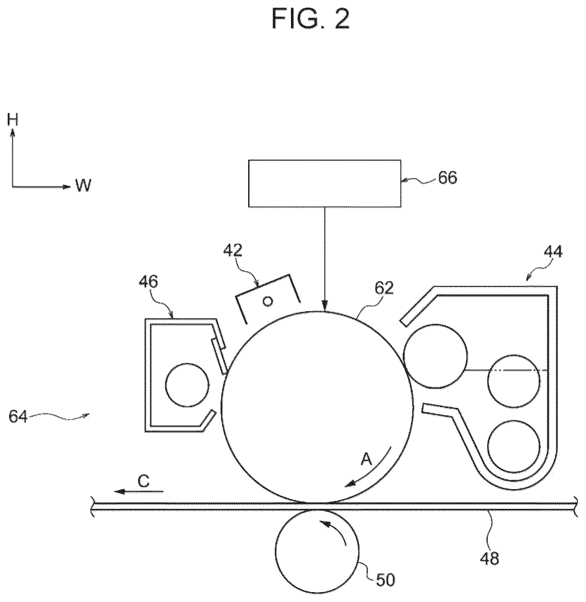

As illustrated in FIG. 2, each image forming unit 64 includes a photoconductor drum 62, a charger 42, a developer 44, and a cleaning member 46. The photoconductor drum 62 has a cylindrical shape and rotates in a direction indicated by an arrow A in FIG. 2. The charger 42 charges the photoconductor drum 62. The developer 44 develops an electrostatic latent image, which will be described later, to visualize the electrostatic latent image as a toner image.

The image forming section 60 further includes exposure devices 66K, 66C, 66M, and 66Y (see FIG. 1) each of which irradiates a corresponding one of the photoconductor drums 62 charged by the charger 42 with exposure light to form an electrostatic latent image.

In this configuration, the charger 42 charges the rotating photoconductor drum 62, and the exposure device 66 irradiates the charged photoconductor drum 62 with exposure light to form an electrostatic latent image. In addition, the developer 44 develops the electrostatic latent image to visualize the electrostatic latent image as a toner image.

### —Transfer Unit 68—

As illustrated in FIG. 1, the transfer unit 68 includes a transfer belt 48, first transfer rollers 50, and a second transfer roller 52. The transfer belt 48 has an endless shape. Each first transfer roller 50 transfers a toner image from the corresponding photoconductor drum 62 (see FIG. 2) onto the transfer belt 48. The second transfer roller 52 transfers the toner images on the transfer belt 48 onto each sheet member P. The transfer unit 68 further includes an auxiliary roller 54 and a plurality of rollers 56. The auxiliary roller 54 is disposed on a side opposite to the second transfer roller 52 with the transfer belt 48 sandwiched therebetween. The transfer belt 48 is wound around the plurality of rollers 56.

The transfer belt 48 has a triangular shape with a vertex facing downward when viewed from the depth direction. The photoconductor drums 62 and the first transfer rollers 50 sandwich a base of the triangular shape of the transfer belt 48. In addition, the second transfer roller 52 and the auxiliary roller 54 sandwich the vertex portion of the triangular shape of the transfer belt 48.

One of the plurality of rollers 56 functions as a drive roller that drives the transfer belt 48 to move in a continuous loop in a direction indicated by an arrow C in FIG. 1.

### (Action of Image Forming Apparatus)

The image forming apparatus 10 forms an image in the following manner.

First, the chargers 42 for the respective colors illustrated in FIG. 2 uniformly negatively charge surfaces of the rotating photoconductor drums 62 for the respective colors at a predetermined potential. Subsequently, the exposure devices 66 (see FIG. 1) for the respective colors irradiate the charged surfaces of the photoconductor drums 62 for the respective colors with exposure light to form electrostatic latent images on the basis of image data read by the document reading section 16 (see FIG. 1).

As a result, the electrostatic latent images corresponding to the image data are formed on the surfaces of the photoconductor drums 62 for the respective colors. The developers 44 for the respective colors develop the electrostatic latent images to visualize the electrostatic latent images as toner images. The toner images formed on the surfaces of the photoconductor drums 62 for the respective colors are sequentially transferred onto the transfer belt 48 by the first transfer rollers 50.

Each sheet member P, which is fed from one of the first accommodation section 22, the second accommodation section 24, the third accommodation section 26, and the fourth accommodation section 28 illustrated in FIG. 1 to the conveying path 30 by the corresponding feed roller 32, is fed to the transfer position T where the transfer belt 48 and the second transfer roller 52 are in contact with each other. When the sheet member P is conveyed between the transfer belt 48 and the second transfer roller 52 at the transfer position T, the toner images on the transfer belt 48 are transferred onto the sheet member P.

The fixing device 58 fixes the toner images transferred onto the sheet member P to the sheet member P. Then, the sheet member P to which the toner images have been fixed is discharged to the discharge section 80 disposed outside the apparatus main body 10a.

### (Configuration of Main Part)

Next, the medium conveying device 100 will be described.

As illustrated in FIG. 1, the medium conveying device 100 is disposed at the end portion of the transition portion of the conveying path 30 where the conveying direction of the sheet members P changes. In other words, when viewed from the depth direction, the medium conveying device 100 is disposed at a portion that connects a portion where the conveying path 30 is curved and a portion where the conveying path 30 extends in the width direction. Thus, the medium conveying device 100 is disposed at a portion where it is necessary for the medium conveying device 100 to increase a nipping force with respect to the recording medium when conveying thick paper and plain paper as the recording medium, and where, when conveying thin paper with a nipping force as that for thick paper and plain paper, wrinkles or roll marks are formed on the thin paper.

The medium conveying device 100 can be mounted on and dismounted from the apparatus main body 10a of the image forming apparatus 10 in the depth direction. Specifically, when a user opens an opening/closing cover (not illustrated) provided in the image forming apparatus 10 and pulls out the medium conveying device 100 mounted on the apparatus main body 10a to the near side in the depth direction, the medium conveying device 100 is dismounted from the apparatus main body 10a.

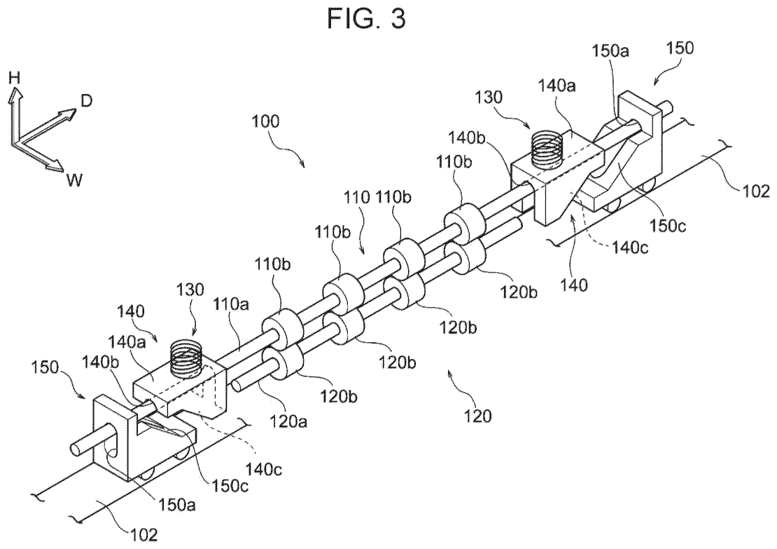

FIG. 3 illustrates a state where the medium conveying device 100 is dismounted from the apparatus main body 10a. As illustrated in FIG. 3, the medium conveying device 100 includes a pair of rollers 110 and 120 arranged in the up-down direction, biasing members 130, and transmission members 140. The biasing members 130 bias the roller 110 toward the roller 120. The transmission members 140 transmit the biasing force of the biasing members 130 to the roller 110. The medium conveying device 100 further includes adjustment members 150 that adjust the biasing force, of the biasing members 130, transmitted by the transmission members 140 to the roller 110 by causing the transmission members 140 to approach or be separated from the roller 110 in the up-down direction (biasing direction).

The biasing members 130, the transmission members 140, and the adjustment members 150 are each provided to form a pair and arranged symmetrically with respect to the center of the medium conveying device 100 in the depth direction. In the following description, the biasing member 130, the transmission member 140, and the adjustment member 150 disposed on the far side in the depth direction will be mainly described.

### [Roller 110 and Roller 120]

As illustrated in FIG. 3, the roller 110 and the roller 120 are arranged in the up-down direction, and the roller 110 is disposed on the upper side with respect to the roller 120. The medium conveying device 100 is configured to convey each recording medium while nipping the recording medium between the roller 110 and the roller 120. The roller 110 is an example of a first roller, and the roller 120 is an example of a second roller.

### —Roller 110—

The roller 110 includes a shaft portion 110a extending in the depth direction and a plurality of roller portions 110b attached to the shaft portion 110a. An axial direction of the shaft portion 110a is aligned with the depth direction. Each roller portion 110b is made of an elastic material or a resin material and has a sleeve shape. In the present exemplary embodiment, as an example, four roller portions 110b are provided and attached to the shaft portion 110a at intervals in the depth direction. The roller 110 is supported by a support member (not illustrated) so as to be movable in the up-down direction and rotatable about its axis. In this manner, the roller 110 functions as a driven roller.

### —Roller 120—

The roller 120 includes a shaft portion 120a extending in the depth direction and a plurality of roller portions 120b attached to the shaft portion 120a. An axial direction of the shaft portion 120a is aligned with the depth direction. Each roller portion 120b is made of an elastic material or a resin material and has a sleeve shape. In the present exemplary embodiment, as an example, four roller portions 120b are provided and attached to the shaft portion 120a at intervals in the depth direction.

The length of the shaft portion 120a of the roller 120 is shorter than the length of the shaft portion 110a of the roller 110. In other words, both end portions of the shaft portion 110a of the roller 110 protrude in the depth direction from both end portions of the shaft portion 120a of the roller 120. The roller 120 is configured to rotate by a driving force transmitted from a driving source (not illustrated). In this manner, the roller 120 functions as a drive roller.

### [Biasing Member 130, Transmission Member 140]

As illustrated in FIG. 3, the biasing member 130 and the transmission member 140 are arranged in the up-down direction, and the biasing member 130 is disposed on the upper side with respect to the transmission member 140.

The biasing member 130 is a compression coil spring disposed so as to extend in the up-down direction. An upper end of the biasing member 130 is supported by a support member (not illustrated). In this manner, the biasing direction of the biasing member 130 with respect to the roller 110 is aligned with the up-down direction.

The transmission member 140 is made of a resin material, and is disposed between the shaft portion 110a of the roller 110 and the biasing member 130. The transmission member 140 has a rectangular shape extending in the up-down direction when viewed from the depth direction, and has a rectangular shape extending in the depth direction when viewed from the up-down direction.

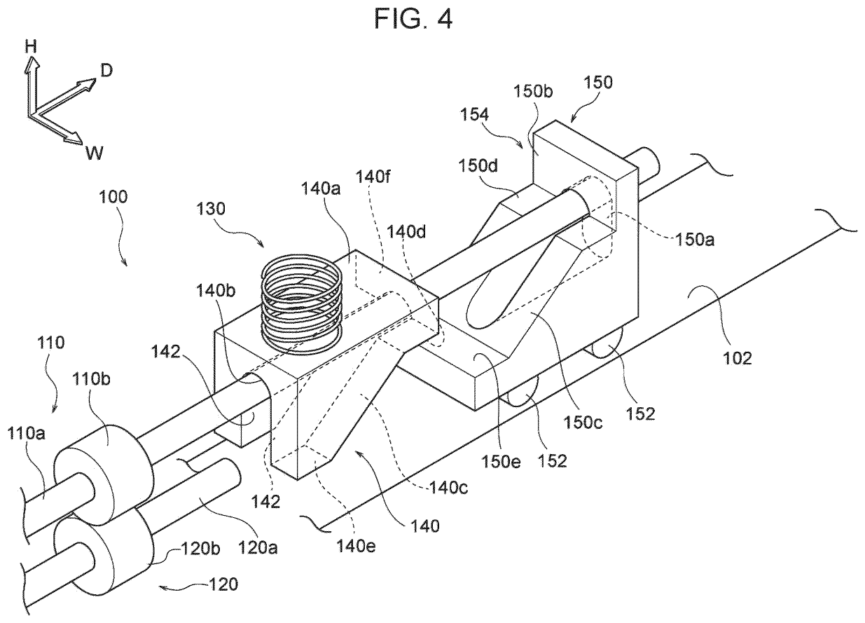

Specifically, as illustrated in FIG. 4, the transmission member 140 is formed with a contact surface 140a and a U-shaped groove 140b. The contact surface 140a is in contact with a lower end of the biasing member 130 and faces upward. The U-shaped groove 140b is an opening formed in the lower side when viewed from the depth direction and has a U-shape. The shaft portion 110a passes through the U-shaped groove 140b. The U-shaped groove 140b has a pair of sandwiching surfaces 142 that sandwich the shaft portion 110a from the width direction. The width direction is an example of an intersecting direction.

As described above, the shaft portion 110a passes through the U-shaped groove 140b. As a result, the transmission member 140 is restricted by the roller 110 from moving relative to the roller 110 in the intersecting direction (width direction) intersecting the biasing direction (up-down direction) of the biasing member 130 and the axial direction (depth direction).

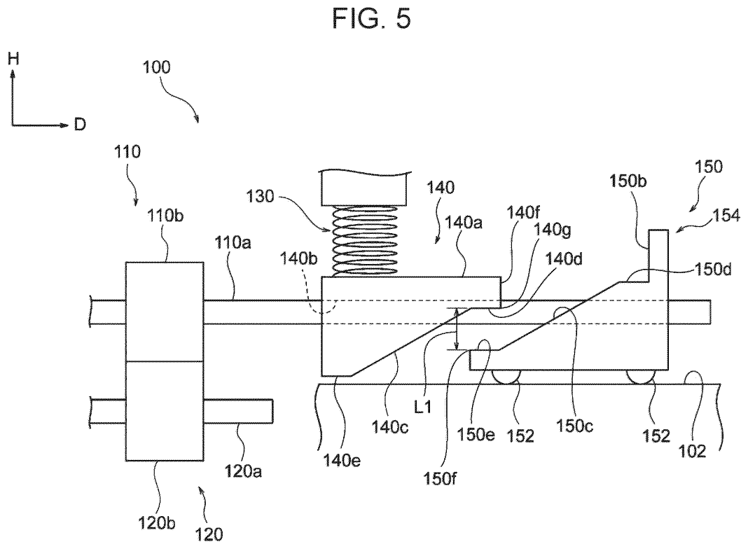

Furthermore, as illustrated in FIG. 5, the transmission member 140 is formed with an inclined surface 140c, a downward-facing surface 140d, and a downward-facing surface 140e. The inclined surface 140c is inclined with respect to the depth direction when viewed from the width direction. The downward-facing surface 140d is connected to an upper end of the inclined surface 140c and faces downward. The downward-facing surface 140e is connected to a lower end of the inclined surface 140c and faces downward. The inclined surface 140c is inclined with respect to the depth direction such that the inclined surface 140c faces outward in the depth direction with a portion on the inner side in the depth direction being lower than a portion on the outer side in the depth direction. The transmission member 140 is further formed with a depth surface 140f that is disposed between the contact surface 140a and the downward-facing surface 140d and faces the far side in the depth direction.

Furthermore, the transmission member 140 is restricted by a restricting member (not illustrated) from moving inward in the depth direction and from rotating about the circumferential direction of the shaft portion 110a.

Here, the phrase “outward in the depth direction” refers to a side facing opposite to the center of the medium conveying device 100 in the depth direction, while the phrase “inward in the depth direction” refers to a side facing the center of the medium conveying device 100 in the depth direction.

### [Adjustment Member 150]

The adjustment member 150 is made of a resin material, and is disposed on the outer side of the transmission member 140 in the depth direction as illustrated in FIGS. 3 and 4. The adjustment member 150 has a rectangular shape extending in the up-down direction when viewed from the depth direction, and has a rectangular shape extending in the depth direction when viewed from the up-down direction.

Specifically, as illustrated in FIG. 4, the adjustment member 150 is formed with a plurality of protrusions 152 protruding downward at four corners of the adjustment member 150. The protrusions 152 are in contact with a guide surface 102 that is provided in the medium conveying device 100 and faces upward. Thus, the adjustment member 150 is supported on the guide surface 102. The guide surface 102 is formed with a guide shape (not illustrated) that guides the movement of the adjustment member 150 in the depth direction. The depth direction is an example of the axial direction.

The adjustment member 150 is further formed with a through hole 150a and a protruding portion 154. The through hole 150a has a slot shape that extends in the up-down direction and through which the shaft portion 110a passes. The protruding portion 154 protrudes upward with respect to the contact surface 140a of the transmission member 140 in the up-down direction. The protruding portion 154 of the adjustment member 150 is formed with a depth surface 150b facing inward in the depth direction.

As illustrated in FIG. 5, the adjustment member 150 is further formed with an inclined surface 150c, an upward-facing surface 150d, and an upward-facing surface 150e. The inclined surface 150c is inclined with respect to the depth direction when viewed from the width direction. The upward-facing surface 150d is connected to an upper end of the inclined surface 150c and faces upward. The upward-facing surface 150e is connected to a lower end of the inclined surface 150c and faces upward. The inclined surface 150c is an example of another inclined surface.

The inclined surface 150c is inclined with respect to the depth direction such that the inclined surface 150c faces inward in the depth direction with a portion on the inner side in the depth direction being lower than a portion on the outer side in the depth direction.

In this configuration, the shaft portion 110a is in contact with the bottom of the U-shaped groove 140b of the transmission member 140 in a state where the adjustment member 150 is disposed at a first position away from the transmission member 140 in the depth direction (see FIG. 5), and the biasing force of the biasing member 130 is transmitted to the roller 110. Also, in this state, the upward-facing surface 150e of the adjustment member 150 and the downward-facing surface 140d of the transmission member 140 face each other in the up-down direction. The clearance in the up-down direction between the adjustment member 150 disposed at the first position and the transmission member 140 is a distance between the upward-facing surface 150e and the downward-facing surface 140d. In the present exemplary embodiment, the clearance is referred to as a clearance L1.

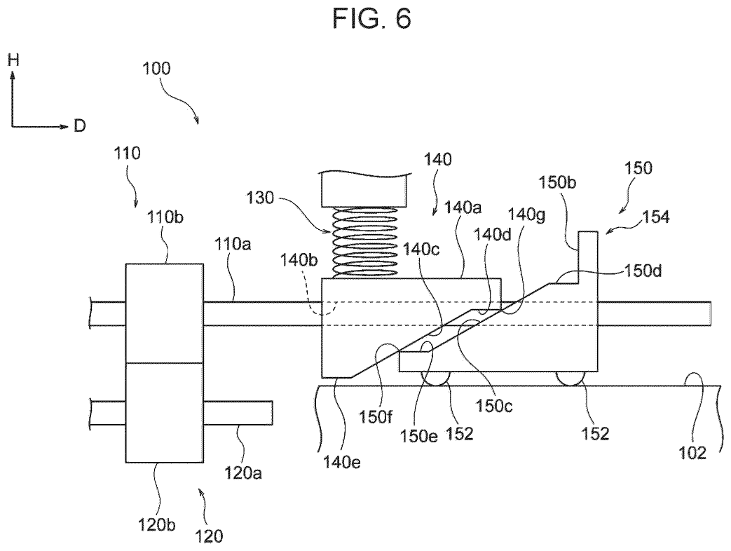

Then, when a user moves the adjustment member 150 disposed at the first position inward in the depth direction, as illustrated in FIGS. 5 and 6, a distal end portion 150f of the upward-facing surface 150e of the adjustment member 150 comes into contact with the inclined surface 140c of the transmission member 140. In addition, the inclined surface 150c of the adjustment member 150 comes into contact with a distal end portion 140g of the downward-facing surface 140d of the transmission member 140. The distal end portion 150f is an example of a pressing portion, and the distal end portion 140g is an example of another pressing portion.

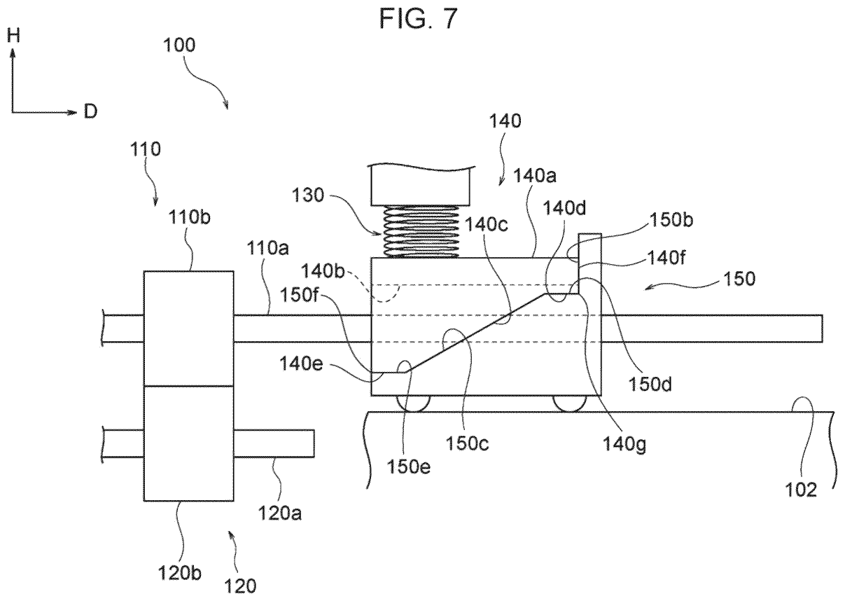

When the user further moves the adjustment member 150 inward in the depth direction, as illustrated in FIGS. 6 and 7, the distal end portion 150f presses the inclined surface 140c, and the distal end portion 140g presses the inclined surface 150c. Thus, the transmission member 140 moves upward, away from the shaft portion 110a of the roller 110. As a result, the adjustment member 150 is disposed at a second position, and the biasing force applied by the biasing member 130 to the roller 110 is not transmitted to the roller 110.

In addition, in a state where the adjustment member 150 is disposed at the second position, the inclined surface 150c of the adjustment member 150 and the inclined surface 140c of the transmission member 140 are in surface contact with each other, and the upward-facing surface 150e of the adjustment member 150 and the downward-facing surface 140e of the transmission member 140 are in surface contact with each other. Furthermore, the upward-facing surface 150d of the adjustment member 150 and the downward-facing surface 140d of the transmission member 140 are in surface contact with each other, and the depth surface 150b of the adjustment member 150 and the depth surface 140f of the transmission member 140 are in surface contact with each other.

### (Action)

Next, the action of the medium conveying device 100 will be described.

In a case where the medium conveying device 100 conveys thick paper or plain paper as a recording medium, the pair of adjustment members 150, each arranged on one of both sides in the depth direction, are each disposed at the first position as illustrated in FIGS. 3 and 5. With such an arrangement, the biasing force of the biasing members 130 is transmitted to the roller 110 by the transmission members 140, and the force with which the recording medium is nipped between the roller 110 and the roller 120 increases. In this state, the medium conveying device 100 conveys thick paper or plain paper as a recording medium.

On the other hand, in a case where the medium conveying device 100 conveys thin paper as a recording medium, the medium conveying device 100 mounted on the apparatus main body 10a (see FIG. 1) is pulled out to the near side in the depth direction by a user, and is dismounted from the apparatus main body 10a.

Then, as illustrated in FIGS. 5, 6, and 7, the adjustment member 150 in a state of being disposed at the first position is moved inward in the depth direction by a user to the second position. In a state where the adjustment member 150 is disposed at the second position, the transmission member 140 has moved upward, away from the shaft portion 110a of the roller 110. With such an arrangement, the biasing force applied by the biasing member 130 is not transmitted to the roller 110. As a result, the force with which the recording medium is nipped between the roller 110 and the roller 120 becomes weaker compared to a case where the medium conveying apparatus 100 conveys thick paper and plain paper. In this state, the medium conveying device 100 conveys thin paper as a recording medium.

As described above, the medium conveying device 100 applies a strong nipping force to the recording medium in a case where the medium conveying device 100 conveys thick paper and plain paper as the recording medium, and applies a weaker nipping force to the recording medium in a case where the medium conveying device 100 conveys thin paper as the recording medium compared to the case where the medium conveying device 100 conveys thick paper and plain paper. With such a configuration, the formation of wrinkles or roll marks on thin paper is suppressed.

### (Recapitulation)

As described above, in the medium conveying device 100, the transmission member 140 is formed with the pair of sandwiching surfaces 142 that sandwich the shaft portion 110a from the width direction. With such a configuration, the transmission member 140 is suppressed from moving relative to the roller 110 in the intersecting direction (width direction) intersecting the biasing direction (up-down direction) and the axial direction (depth direction) of the roller 110 compared to a case where the transmission member is in contact with the roller only from the biasing direction (up-down direction) of the biasing member.

In the medium conveying device 100, the transmission member 140 is formed with the pair of sandwiching surfaces 142 that sandwich the shaft portion 110a from the width direction. With such a configuration, the movement of the transmission member 140 is easily suppressed compared to a case where the movement of the transmission member is suppressed by bringing a distal end of a protrusion formed in the transmission member into contact with the roller.

In addition, in the medium conveying device 100, the pair of sandwiching surfaces 142 form portions of the U-shaped groove 140b that opens downward. With such a configuration, the assembly of the transmission member 140 to the roller 110 becomes easier compared to a case where an elongated hole has a pair of sandwiching surfaces.

In addition, in the medium conveying device 100, by moving the adjustment member 150 inward in the depth direction (axial direction), the distal end portion 150f of the adjustment member 150 presses the inclined surface 140c of the transmission member 140, and the transmission member 140 moves upward. With such a configuration, a load applied to the roller 110 in the width direction when the transmission member 140 is moved upward is reduced compared to a case where the distal end portion presses the inclined surface by moving the transmission member in the width direction (intersecting direction).

In addition, in the medium conveying device 100, by moving the adjustment member 150 inward in the depth direction (axial direction), the distal end portion 150f of the adjustment member 150 presses the inclined surface 140c of the transmission member 140, and the distal end portion 140g of the transmission member 140 presses the inclined surface 150c of the adjustment member 150. Thus, the transmission member 140 moves upward. With such a configuration, the posture of the transmission member 140 that moves is stable compared to a case where the inclined surface is formed on only either the adjustment member or the transmission member.

In addition, in the image forming apparatus 10, the movement of the transmission member 140 relative to the roller 110 is suppressed compared to a case where the image forming apparatus 10 includes a medium conveying device in which the transmission member is in contact with the roller only from the biasing direction of the biasing member. Thus, variation in the biasing force of the biasing member 130 on the roller 110 is suppressed.

### Second Exemplary Embodiment

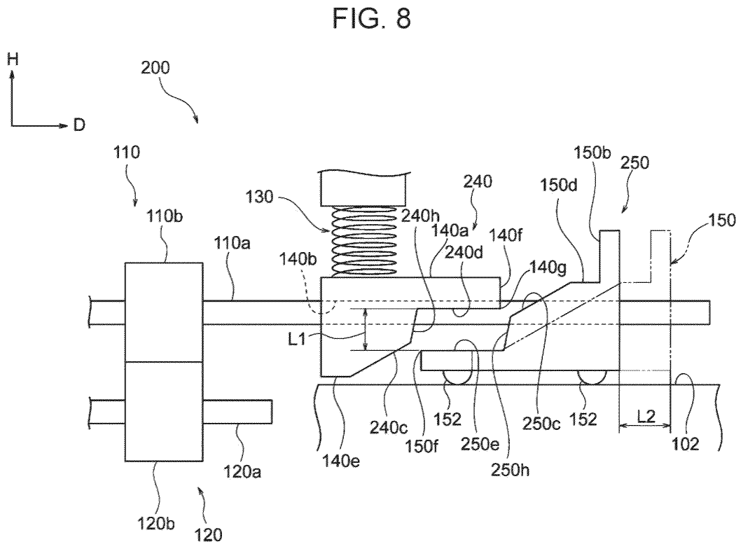

Next, an example of a medium conveying device according to a second exemplary embodiment will be described with reference to FIGS. 8 to 10. The second exemplary embodiment will mainly describe differences from the first exemplary embodiment.

As illustrated in FIG. 8, a medium conveying device 200 according to the second exemplary embodiment includes the pair of rollers 110 and 120, the biasing members 130, and transmission members 240. The biasing members 130 bias the roller 110 toward the roller 120. The transmission members 240 transmit the biasing force of the biasing members 130 to the roller 110. The medium conveying device 200 further includes adjustment members 250 that adjust the biasing force transmitted by the transmission members 240 to the roller 110.

### [Transmission Member 240]

As illustrated in FIG. 8, the transmission member 240 is formed with an inclined surface 240c and a downward-facing surface 240d. The inclined surface 240c is inclined with respect to the depth direction when viewed from the width direction. The downward-facing surface 240d is connected to the distal end portion 140g. The transmission member 240 is further formed with a connection surface 240h with one end being connected to an upper end of the inclined surface 240c and the other end being connected to the downward-facing surface 240d.

The connection surface 240h has a larger inclination angle with respect to the depth direction than the inclined surface 240c. When the adjustment member 250 at the first position illustrated in FIG. 8 is moved inward in the depth direction, the distal end portion 150f of the adjustment member 250 comes into contact with the upper end portion of the inclined surface 240c and presses the inclined surface 240c.

### [Adjustment Member 250]

As illustrated in FIG. 8, the adjustment member 250 is formed with an inclined surface 250c and an upward-facing surface 250e. The inclined surface 250c is inclined with respect to the depth direction when viewed from the width direction. The upward-facing surface 250e is connected to the distal end portion 150f. The adjustment member 250 is further formed with a connection surface 250h with one end being connected to a lower end of the inclined surface 250c and the other end being connected to the upward-facing surface 250e.

The connection surface 250h has a larger inclination angle with respect to the depth direction than the inclined surface 250c. When the adjustment member 250 at the first position illustrated in FIG. 8 is moved inward in the depth direction, the distal end portion 140g of the transmission member 240 comes into contact with the lower end portion of the inclined surface 250c and presses the inclined surface 250c.

As described above, the transmission member 240 is formed with the connection surface 240h having a larger inclination angle than the inclined surface 240c, and the adjustment member 250 is formed with the connection surface 250h having a larger inclination angle than the inclined surface 250c. With such a configuration, in a state where the clearance L1 is ensured in the up-down direction between the adjustment member 250 disposed at the first position and the transmission member 240, the adjustment member 250 can be disposed on the inner side in the depth direction compared to the adjustment member 150 according to the first exemplary embodiment. In other words, the movement amount (stroke amount) of the adjustment member 250 from the first position to the second position can be made shorter, by a distance L2, illustrated in FIG. 8, than the movement amount of the adjustment member 150 from the first position to the second position.

### (Action)

Next, the action of the medium conveying device 200 will be described.

In a case where the medium conveying device 200 conveys thick paper or plain paper as a recording medium, a pair of adjustment members 250, each arranged on one of both sides in the depth direction, are each disposed at the first position as illustrated in FIG. 8. With such an arrangement, the biasing force of the biasing members 130 is transmitted to the roller 110 by the transmission members 240, and the force with which the recording medium is nipped between the roller 110 and the roller 120 increases. In this state, the medium conveying device 200 conveys thick paper or plain paper as a recording medium.

On the other hand, in a case where the medium conveying device 200 conveys thin paper as a recording medium, the medium conveying device 200 mounted on the apparatus main body 10a (see FIG. 1) is pulled out to the near side in the depth direction by a user, and is dismounted from the apparatus main body 10a.

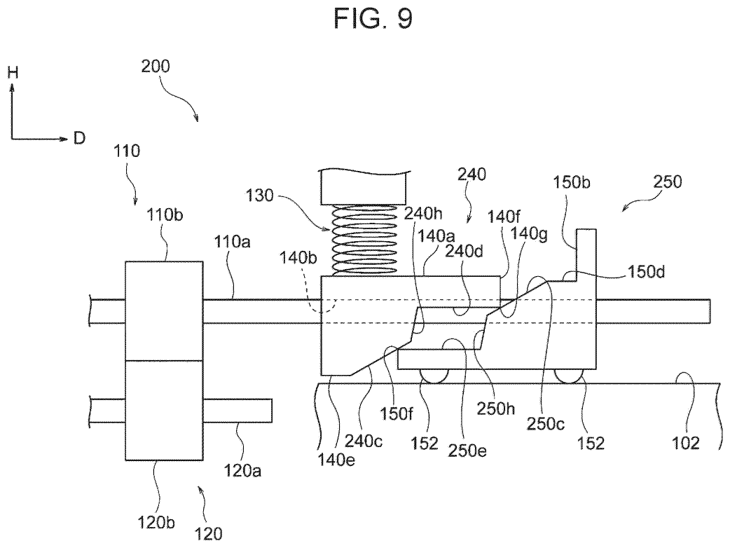

Then, when a user moves the adjustment member 250 disposed at the first position inward in the depth direction, as illustrated in FIGS. 8 and 9, the distal end portion 150f of the adjustment member 250 comes into contact with the upper end portion of the inclined surface 240c of the transmission member 240. In addition, the lower end portion of the inclined surface 250c of the adjustment member 250 comes into contact with the distal end portion 140g of the transmission member 240.

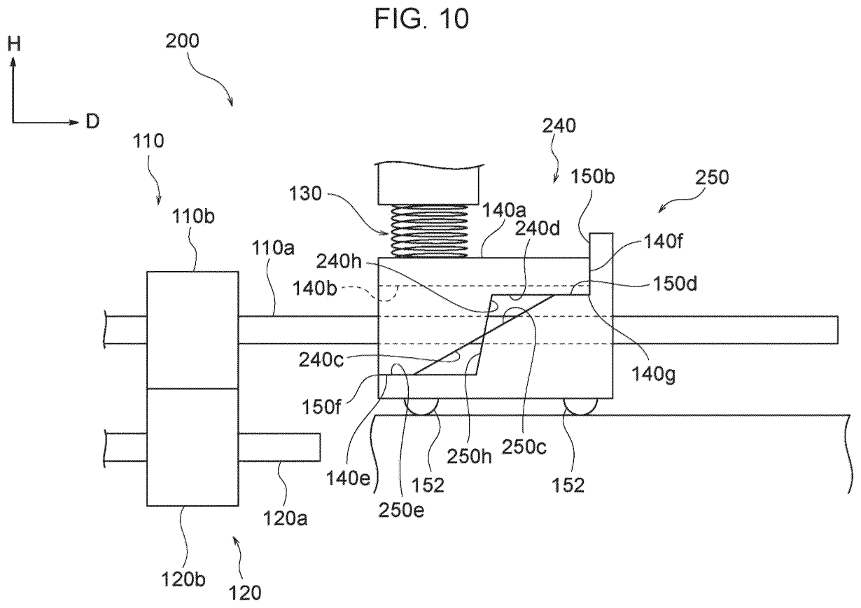

When the user further moves the adjustment member 250 inward in the depth direction, as illustrated in FIGS. 9 and 10, the distal end portion 150f presses the inclined surface 240c, and the distal end portion 140g presses the inclined surface 250c. Thus, the transmission member 240 moves upward, away from the shaft portion 110a of the roller 110. As a result, the adjustment member 250 is disposed at the second position, and the biasing force applied by the biasing member 130 is not transmitted to the roller 110.

The present disclosure has been described in detail with respect to specific exemplary embodiments, but the present disclosure is not limited to the exemplary embodiments, and it is apparent to those skilled in the art that the present disclosure can adopt various other exemplary embodiments within the scope of the present disclosure. For example, in the above-described exemplary embodiments, the medium conveying devices 100 and 200 are used in the image forming apparatus 10. However, the medium conveying devices 100 and 200 may be used in a pre-processing device of the image forming apparatus, a post-processing device of the image forming apparatus, a ticketing machine that conveys and sells tickets, an ATM that conveys and dispenses or accepts bills, and the like.

In the above-described exemplary embodiments, the roller 110 and the roller 120 are arranged in the up-down direction, but may be arranged in a direction other than the up-down direction.

In the above-described exemplary embodiments, the adjustment members 150 and 250 are moved. However, it is sufficient for the adjustment members 150 and 250 and the transmission members 140 and 240 to be moved relative to each other in the depth direction.

In the above-described exemplary embodiments, the transmission members 140 and 240 and the shaft portion 110a of the roller 110 are separated from each other in a state where the adjustment members 150 and 250 are moved to the second position, but may not be separated from each other. It is sufficient for the adjustment members 150 and 250 to adjust the degree of the biasing force transmitted by the transmission members 140 and 240.

Although not particularly described in the above-described exemplary embodiments, displaying, on the display section 40 (see FIG. 1), the type of paper of the recording medium to be used may accordingly allow a user to move the adjustment members 150 and 250.

Although not particularly described in the above-described exemplary embodiments, in order to ensure a minimum nipping force for nipping the recording medium between the roller 110 and the roller 120, an additional biasing member may be provided separately from the biasing members 130.

In the above-described exemplary embodiments, the transmission members 140 and 240 are each formed with the U-shaped groove 140b that has the pair of sandwiching surfaces 142 and opens downward. However, an elongated hole extending in the up-down direction may have a pair of sandwiching surfaces. In this case, the effect achieved by forming the U-shaped groove 140b is not achieved.

In the above-described exemplary embodiments, the inclined surface is formed on both the transmission members 140 and 240 and the adjustment members 150 and 250. However, the inclined surface may be formed on either the transmission members 140 and 240 or the adjustment members 150 and 250. In this case, the effect achieved by forming the inclined surface on both the transmission members 140 and 240 and the adjustment members 150 and 250 is not achieved.

In the above-described exemplary embodiments, the adjustment members 150 and 250 are moved in the depth direction (axial direction), but may be moved in the width direction, for example. In this case, the effect achieved by moving the adjustment members 150 and 250 in the depth direction (axial direction) is not achieved.

### APPENDIX

(((1)))

A medium conveying device comprising:
a first roller that is rotatably supported;
a second roller that conveys a recording medium while nipping the recording medium between the first roller and the second roller;
a biasing member that is disposed on a side opposite to the second roller with the first roller interposed between the second roller and the biasing member and biases the first roller toward the second roller;
a transmission member that is disposed between the biasing member and the first roller, is restricted by the first roller from moving relative to the first roller in an intersecting direction intersecting a biasing direction of the biasing member and an axial direction of the first roller, and transmits a biasing force of the biasing member to the first roller; and
an adjustment member that adjusts the biasing force applied by the biasing member to the first roller by causing the transmission member to approach or be separated from the first roller in the biasing direction.
   (((2)))

The medium conveying device according to (((1))), wherein the transmission member is formed with a pair of sandwiching surfaces that sandwich the first roller from the intersecting direction.

(((3)))

The medium conveying device according to (((2))), wherein the transmission member is formed with a U-shaped groove that has the pair of sandwiching surfaces and opens in the biasing direction.

(((4)))

The medium conveying device according to any one of (((1))) to (((3))), wherein
the transmission member is formed with an inclined surface that is inclined with respect to the axial direction, and
the adjustment member is formed with a pressing portion that presses the inclined surface and causes the transmission member to be separated from the first roller when the adjustment member moves in the axial direction relative to the transmission member.
   (((5)))

The medium conveying device according to (((4))), wherein
the adjustment member is formed with another inclined surface that is inclined with respect to the axial direction, and
the transmission member is formed with another pressing portion that presses the another inclined surface and causes the transmission member to be separated from the first roller when the adjustment member moves.
   (((6)))

An image forming apparatus, comprising:
the medium conveying device according to any one of (((1))) to (((5))); and
an image forming section that forms an image on a recording medium conveyed by the medium conveying device.

What is claimed is:

1. A medium conveying device comprising:
a first roller that is rotatably supported;
a second roller that conveys a recording medium while nipping the recording medium between the first roller and the second roller;
a biasing member that is disposed on a side opposite to the second roller with the first roller interposed between the second roller and the biasing member and biases the first roller toward the second roller;
a transmission member that is disposed between the biasing member and the first roller, is restricted by the first roller from moving relative to the first roller in an intersecting direction intersecting a biasing direction of the biasing member and an axial direction of the first roller, and transmits a biasing force of the biasing member to the first roller; and
an adjustment member that adjusts the biasing force applied by the biasing member to the first roller by causing the transmission member to approach or be separated from the first roller in the biasing direction.

2. The medium conveying device according to claim 1, wherein the transmission member is formed with a pair of sandwiching surfaces that sandwich the first roller from the intersecting direction.

3. The medium conveying device according to claim 2, wherein the transmission member is formed with a U-shaped groove that has the pair of sandwiching surfaces and opens in the biasing direction.

4. The medium conveying device according to claim 1, wherein
the transmission member is formed with an inclined surface that is inclined with respect to the axial direction, and
the adjustment member is formed with a pressing portion that presses the inclined surface and causes the transmission member to be separated from the first roller when the adjustment member moves in the axial direction relative to the transmission member.

5. The medium conveying device according to claim 4, wherein
the adjustment member is formed with another inclined surface that is inclined with respect to the axial direction, and
the transmission member is formed with another pressing portion that presses the another inclined surface and causes the transmission member to be separated from the first roller when the adjustment member moves.

6. An image forming apparatus, comprising:
the medium conveying device according to claim 1; and
an image forming section that forms an image on a recording medium conveyed by the medium conveying device.

7. An image forming apparatus, comprising:
the medium conveying device according to claim 2; and
an image forming section that forms an image on a recording medium conveyed by the medium conveying device.

8. An image forming apparatus, comprising:
the medium conveying device according to claim 3; and
an image forming section that forms an image on a recording medium conveyed by the medium conveying device.

9. An image forming apparatus, comprising:
the medium conveying device according to claim 4; and
an image forming section that forms an image on a recording medium conveyed by the medium conveying device.

10. An image forming apparatus, comprising:
the medium conveying device according to claim 5; and
an image forming section that forms an image on a recording medium conveyed by the medium conveying device.
